(19) United States
(12) Patent Application Publication
(10) Pub. No.: US 2007/0263557 A1
(43) Pub. Date: Nov. 15, 2007

(54) Apparatus for eliminating interference from broadcast signals with satellite signals

(76) Inventor: Richard Hulse, Slate Hill, NY (US)

Correspondence Address: JOHN MAIER, III, 660 AARON COURT, KINGSTON, NY, 12401, US

(21) Appl. No.: 11/431,262

(22) Filed: May 10, 2006

(51) Int. Cl. H04B 7/185

(52) U.S. Cl. 370/316

(57) ABSTRACT

An apparatus is provided for reception of satellite signals without interference from broadcast signals. An audio receiver-player is connected to a broadcast antenna by an antenna cable. A switch is located in the antenna cable to disconnect the broadcast antenna from the audio receiver player. A satellite receiver transmits satellite signals to the audio receiver player. When the satellite receiver is used, the switch is opened which prevents broadcast reception and thus interference with the satellite reception from broadcast signals.

### BACKGROUND OF THE INVENTION

1. Field of the Invention

This invention relates to satellite reception and, most specifically, to satellite reception without interference from broadcast signals.

2. Pior Art

Broadcast reception, namely radio reception, has been well known for some time. It is effectively and extensively used in motor vehicles. When traveling for long distances in a motor vehicle, broadcast transmission will fade out eventually as the motor vehicle moves from the selected broadcast range.

Recently, satellite transmission has become available. Satellite transmission offers continuous reception virtually anywhere. Therefore, selection of a satellite station permits continuous reception of the type of programming presented by that satellite station. When a satellite reception is desired, it is necessary to locate a place on the broadcast dial of the radio or audio receiver player where no broadcast reception currently exists. At that point, the satellite reception is directed to that particular place on the frequency modulation dial. This procedure is fine, at least for awhile, but sooner or later when traveling in a motor vehicle, broadcast interference will occur from a broadcast station with the satellite reception.

### OBJECTS

Therefore, the objects of this invention are as follows:

1. To provide an apparatus to assure satellite reception without interference from broadcast signals.

2. To provide an apparatus temporarily to disconnect broadcast reception during satellite reception.

3. To provide an apparatus for eliminating broadcast signal reception that is simple and economical.

These and other objects of the present invention will become readily apparent upon further review of the following specifications and drawings.

### SUMMARY OF THE INVENTION

An apparatus is provided for reception of satellite signals without any possible interference from broadcast signals. An audio receiver player is connected to a broadcast antenna. A means is provided to disconnect the broadcast antenna from the audio receiver-player. A satellite receiver transmits satellite signals to the audio receiver player.

### BRIEF DESCRIPTION OF THE DRAWINGS

FIG. 1 is a schematic diagram showing a broadcast antenna, with an antenna cable having a switch located in it and a satellite receiver in the vicinity of the audio receiver player.

### BRIEF DESCRIPTION OF THE NUMERALS

| NUMERAL | DESCRIPTION |
|---|---|
| 11 | Broadcast Antenna |
| 13 | Antenna Cable |
| 15 | Audio Receiver-Player |
| 17 | Satellite Receiver |
| 19 | Switch |

### DETAILED DESCRIPTION OF THE PREFERRED EMBODIMENT

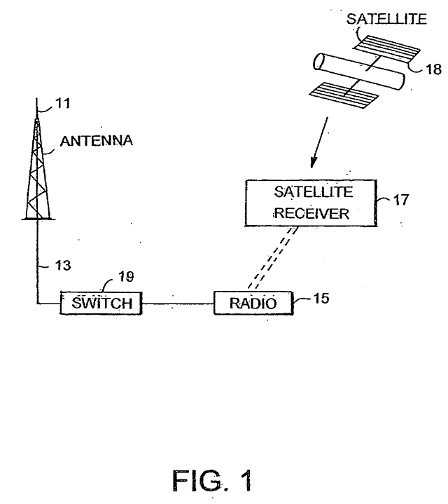

Referring now to FIG. 1, which is the sole FIGURE, a broadcast antenna 11 is shown connected to an antenna cable 13, which in turn is connected to a radio or audio receiver player 15, such as is used in a motor vehicle (not shown).

A satellite receiver 17, to receive satellite signals, is also shown in the vicinity of the audio receiver player 15. The satellite receiver 17 is placed on a motor vehicle so as readily to receive signals from a satellite 18. There is no physical connection between the satellite receiver 17 and the audio receiver player 15, and the satellite receiver 17 transmits signals to the audio receiver-player 15.

A switch 19 is located in the antenna cable 13. When using a satellite receiver 17, the switch 19 is turned off, thereby disconnecting the broadcast antenna 11 from the audio receiver-player 15. As a result of elimination of the broadcast antenna 11, the audio receiver player cannot receive signals through the broadcast antenna 15. The audio receiver-player 15 can only receive signals from the satellite receiver 17 and do so without interference from any broadcast signals being received through the broadcast antenna 11.

It is to be understood that the drawings and description matter are in all cases to be interpreted as merely illustrative of the principles of the invention, rather than as limiting the same in any way, since it is contemplated that various elements might exist to achieve like results without departing from the spirit of the invention or the scope of the appended claims.

1. An apparatus for reception of satellite signals without interference from broadcast signals comprising:
an audio receiver player;
a broadcast antenna connected to the audio receiver-player;
means to disconnect the broadcast antenna from the audio receiver player; and
a satellite receiver to transmit satellite signals to the audio receiver player.

2. An apparatus according to claim 1, wherein the broadcast antenna includes an antenna cable and wherein the means to disconnect the broadcast antenna from the audio receiver player includes a switch.

3. An apparatus for reception of satellite signals without interference from broadcast signals comprising:
an audio receiver player;
a broadcast antenna;
an antenna cable connecting the broadcast antenna to the audio receiver player;
means in the antenna cable to disconnect the antenna from the audio receiver player; and
a satellite receiver to transmit satellite signals to the audio receiver player.

4. An apparatus according to claim 3, wherein the means to disconnect the broadcast antenna from the audio receiver player is a switch.
